(19) United States
(12) Patent Application Publication
(10) Pub. No.: US 2026/0338740 A1
(43) Pub. Date: Oct. 29, 2026

(54) METHOD FOR SEPARATING AND QUANTIFYING FUCOXANTHIN FROM COMPLEX MATRICES

(71) Applicant: Nutraceuticals International Group LLC d/b/a Nutraceuticals Group, Little Falls, NJ (US)

(72) Inventor: David ROMEO, Washington Twp., NJ (US)

(21) Appl. No.: 19/180,224

(22) Filed: Apr. 16, 2025

(51) Int. Cl. G01N 30/14; G01N 1/40; G01N 30/02; G01N 30/06; G01N 30/74

(52) U.S. Cl. CPC G01N 30/14; G01N 1/4077; G01N 30/74; G01N 2001/4088; G01N 2001/4094; G01N 2030/027; G01N 2030/062

(57) ABSTRACT

A method for separating and quantifying fucoxanthin from complex matrices contained in raw materials or dietary supplements includes extracting fucoxanthin from the powdered fucoxanthin test sample by sequentially vortexing in a methanolic extract, sonicating at a pH from about 7.15 to about 7.25, and filtering through a 0.4 to 0.5 micron filter. HPLC analysis is performed on the filtered test solution using a C18 stationary phase column and isocratic methanol:acetonitrile mobile phase flowing through the column at a flow rate of about 0.7 to about 0.8 ml/min and at about 26 to about 32 degrees Celsius with a concentration range of about 1.0 to about 20 micrograms per milliliter and a limit of detection (LOD) of about 0.2 micrograms/milliliter and a limit of quantitation (LOQ) of about 0.6 micrograms/milliliter.

### FIELD OF THE INVENTION

The present invention relates to the field of carotenoids, and more particularly, this invention relates to separating and quantifying fucoxanthin.

### BACKGROUND OF THE INVENTION

Products containing fucoxanthin have been commercially available for years, for example, as dietary supplements. Fucoxanthin is a carotenoid commonly found in the pigment of several different seaweeds, including for example, brown seaweed, and in algae (phaeophyta) and marine diatoms. It is known for its potential health benefits, including antioxidant, anti-inflammatory, anti-cancer, anti-obesity, anti-diabetes, and anti-photo damage properties. Fucoxanthin appears to promote the expression of the UCP1 in white adipose tissue (WAT), which is usually found in brown adipose tissue (BAD). UCP1 plays a role in burning fat for heat, and its up regulation in WAD can contribute to reducing WAT weight. Fucoxanthin may also ameliorate alterations in lipid metabolism and insulin resistance induced by a high-fat diet. It may also prevent chronic diseases such as metabolic syndrome, Type II diabetes, and heart disease.

Often, commercially available fucoxanthin-containing dietary supplements and similar products have not been efficacious because the percentage assay of the “active” fucoxanthin may be less than 2% by weight of total fucoxanthin content, thus limiting the active material. Although HPLC and other analytical techniques have been used to identify the quantities of fucoxanthin, these processes are challenging because of the complex chemical structure of fucoxanthin and its tendency to form isomers, and the presence of other carotenoids from the same source, making it difficult to isolate and actively measure. For example, fucoxanthin is prone to structural isomerization and oxidative cleavage, leading to potential loss of its biological activity, thus complicating HPLC analysis.

Fucoxanthin is a carotenoid that has a unique structure, including an allenic bond, a 5, 6 monoepoxide, and conjugated double bonds, making it susceptible to isomerization. It also exists in both trans and CIS isomers that complicate identification and quantification. Fucoxanthin that is found in brown algae, diatoms, and some supplements may contain other carotenoids and other components like chlorophylls, beta-carotene, and xanthophylls. These other components may interfere with the identification and quantification of fucoxanthin, making it difficult to isolate and quantify. These other components and other complex matrices also interfere with the extraction and purification process, leading to lower yields of fucoxanthin, making analysis difficult. Fucoxanthin is also a relatively unstable compound, which degrades under various conditions, such as exposure to light, heat and oxygen. This instability also impacts the accuracy of any quantification, as the amount of fucoxanthin in a sample may decrease over time, especially during extraction and quantification such as HPLC.

HPLC is often used to identify and quantify fucoxanthin after extraction because a linear relationship exists between the concentration of fucoxanthin and the chromatographic peak area. A calibration plot may be created using standards of known concentrations, where the concentration of fucoxanthin in the extract can be determined by relating the area ratio of each carotenoid and the internal standard to those calibration curves. Because fucoxanthin's structure contains oxygen and other polar functional groups, it is more polar than non-polar carotenoids. Because of its semipolar nature, fucoxanthin is soluble in mid-polar solvents, such as ethanol and acetone, but not water. It has low bio-accessibility in the body because of its non-polar, hydrophobic and insoluble nature in water.

Most HPLC analysis of fucoxanthin is with a reverse phase-HPLC system where the stationary phase is non-polar and the mobile phase is polar. The solutes in the mobile phase travel through the silica pores in the stationary phase, where they are attracted to and held by the hydrocarbon. These polar compounds spend the most time in the stationary phase and move the slowest.

The structural nature of fucoxanthin and other problems addressed above make HPLC difficult. With methanol-acetonitrile phases, methanol is more polar than acetonitrile, so it creates less competition with the stationary phase and allows analytes to stay longer as compared to acetonitrile, which is less polar, so it forms stronger interactions with the stationary phase and can elute analytes earlier. Also, methanol reacts exothermically when mixed with water, while acetonitrile reacts endothermically, indicative that the temperature of an acetonitrile mixture would drop below room temperature and bubbles may form. All these factors make identification and quantification of fucoxanthin, especially from complex matrices, much more challenging than other carotenoids. A more efficient and sustainable process for fucoxanthin extraction and quantification is desired.

### SUMMARY OF THE INVENTION

A method for separating and quantifying fucoxanthin from complex matrices contained in raw materials or dietary supplements may comprise preparing a powdered fucoxanthin test sample from a raw material or dietary supplement having complex matrices containing fucoxanthin. The method includes extracting fucoxanthin from the powdered fucoxanthin test sample by sequentially a) vortexing the powdered fucoxanthin test sample in a methanolic extract to form a test solution, b) sonicating the test solution within an ultrasonic bath containing a buffer at a pH from about 7.15 to about 7.25, and c) filtering the test solution through a 0.4 to 0.5 micron filter.

The method further includes performing a High-Performance Liquid Chromatography (HPLC) analysis on the filtered test solution using a C18 stationary phase column and isocratic methanol:acetonitrile mobile phase flowing through the column at a flow rate of about 0.7 to about 0.8 ml/min at about 26 to about 32 degrees Celsius with a concentration range of about 1.0 to about 20 micrograms per milliliter. The limit of detection (LOD) is about 0.2 micrograms/milliliter and the limit of quantitation (LOQ) is about 0.6 micrograms/milliliter.

The fucoxanthin may be detected after HPLC at about 450 nanometers (nm) using an ultraviolet/visible light (UV/Vis) detector. The fucoxanthin may be detected at about 5.59 to about 5.89 minutes with a tailing factor of about 1.35 at about 5% height. A powdered fucoxanthin test sample that is equivalent to about 400 to 600 micrograms of fucoxanthin may be vortexed for about 2 to 3 minutes in about 30 to about 35 milliliters of methanol. The test solution may be sonicated for about 9 to about 11 minutes at about 38 to about 42 degrees Celsius and allowed to cool to room temperature. About 18 to 22 millimoles of potassium dihydrogen phosphate (H₂KPO₄) may be added to the test sample, mixed and sonicated again for about 9 to about 11 minutes at about 38 to about 42 degrees Celsius. After sonication, the test solution may be cooled at room temperature and homogenized. The test solution may be centrifuged at about 450 to about 550 rpm for about 4 to about 6 minutes.

The C18 stationary phase column may be about 4.6×150 millimeter and 5 micrometer and the injection volume of the test solution is about 20 microliters. The complex matrices may comprise fucoxanthin-chlorophyll protein complexes (FCPs), pigments and proteins. The complex matrices may comprise a biomass having a source of fucoxanthin and one or more of a diatom, brown algae, blue-green algae and green algae.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a high-level flowchart of an example method of extracting, separating and quantifying fucoxanthin in accordance with a non-limiting example.

FIG. 2 is a bar chart of the fucoxanthin extraction from different samples.

FIG. 3 is a chromatogram for a blank injection.

FIG. 4 is a chromatogram for an injection of a fucoxanthin reference.

FIG. 5 is another chromatogram for an injection of fucoxanthin reference.

FIG. 6 is another chromatogram for an injection of fucoxanthin reference at a higher level.

FIG. 7 is a another chromatogram for an injection of fucoxanthin as Fucopure using the methodology as described in FIG. 1.

FIG. 7.

FIG. 8 is another chromatogram similar to that of FIG. 9 is another chromatogram similar to that of FIG. 7.

FIG. 10 is another chromatogram for an injection of sample material of an algae extract without fucoxanthin.

FIGS. 11 and 12 show overlay chromatograms for the fucoxanthin reference standard.

FIG. 13 is a linear regression for a calibration curve for a fucoxanthin reference standard.

FIG. 14 is a chromatogram of an overlay of the fucoxanthin for Fucopure.

FIGS. 15 and 16 are chromatograms for the fucoxanthin reference standard.

FIG. 17 is a chromatogram for fucoxanthin in a specific sample.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

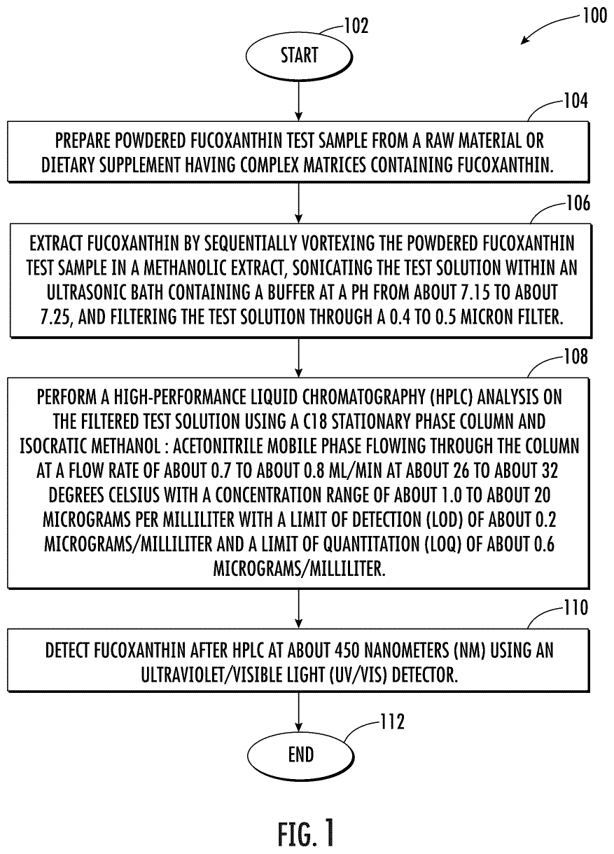

Referring now to FIG. 1, there is illustrated at 100 a flowchart showing a high level method for separating and quantifying fucoxanthin from complex matrices contained in raw materials or dietary supplements. The method starts (Block 102) by preparing a powdered fucoxanthin test sample from a raw material or dietary supplement having complex matrices containing fucoxanthin (Block 104). The method includes extracting fucoxanthin from the powdered fucoxanthin test sample by sequentially a) vortexing the powdered fucoxanthin test sample in a methanolic extract to form a test solution, b) sonicating the test solution within an ultrasonic bath containing a buffer at a pH from about 7.15 to about 7.25, and c) filtering the test solution through a 0.4 to 0.5 micron filter (Block 106).

The method further includes performing a High-Performance Liquid Chromatography (HPLC) analysis on the filtered test solution using a C18 stationary phase column and isocratic methanol:acetonitrile mobile phase flowing through the column at a flow rate of about 0.7 to about 0.8 ml/min at about 26 to about 32 degrees Celsius with a concentration range of about 1.0 to about 20 micrograms per milliliter (Block 108). The limit of detection (LOD) is about 0.2 micrograms/milliliter and the limit of quantitation (LOQ) is about 0.6 micrograms/milliliter.

The fucoxanthin may be detected after HPLC at about 450 nanometers (nm) using an ultraviolet/visible light (UV/Vis) detector (Block 110), although the range may vary slightly in this example by 10 nm above and below 450 nm, or 440 to 460 nm, but 450 nm has been optimum based on fucoxanthin structure and the methodology used as explained herein. In an example, it was found that the fucoxanthin may be detected at about 5.59 to about 5.89 minutes with a tailing factor of about 1.35 with a range of about 1.30 to 1.40 at about 5% or about 4.7% to 5.3% height. The process ends (Block 112).

A powdered fucoxanthin test sample that is equivalent to about 400 to 600 micrograms of fucoxanthin may be vortexed for about 2 to 3 minutes in about 30 to about 35 milliliters of methanol. The test solution may be sonicated for about 9 to about 11 minutes at about 38 to about 42 degrees Celsius and allowed to cool to room temperature. About 18 to 22 millimoles of potassium dihydrogen phosphate (H₂KPO₄) may be added to the test sample, mixed and sonicated again for about 9 to about 11 minutes at about 38 to about 42 degrees Celsius. After sonication, the test solution may be cooled at room temperature and homogenized. The test solution may be centrifuged at about 450 to about 550 rpm for about 4 to about 6 minutes.

The C18 stationary phase column may be about 4.6×150 millimeters and 5 micrometers in a non-limiting example. The injection volume of the test solution may be about 20 microliters. The complex matrices may comprise fucoxanthin-chlorophyll protein complexes (FCPs), pigments and proteins, for example, complex matrices as a biomass having a source of fucoxanthin and one or more of a diatom, brown algae, blue-green algae and green algae.

The validation results show the beneficial results from the process in accordance with a non-limiting example as shown in Table 1. The method validation process proves the analytical technique is acceptable for its intended purpose to obtain reliable results.

TABLE 1
Method Validation Results

| Parameter | Criteria | Result | Pass/Fail | Conclusion |
|---|---|---|---|---|
| Selectivity/ | Acid | There is | Pass | This analytical |
| Specificity | Hydrolysis | degradation of | | method meets fitness |
| | | the standard | | for purpose. Any |
| | | and sample, | | degradant or |
| | | but there are | | impurity can be |
| | | no impurities | | detected at the |
| | | in the | | retention time |
| | | retention | | (5.59-5.89 minutes) for |
| | | time. | | fucoxanthin, |
| | Basic | There is | Pass | ensuring the correct |
| | Hydrolysis | degradation of | | fucoxanthin |
| | | the standard | | detection and |
| | | and sample, | | quantification in |
| | | but there are | | raw materials and |
| | | no impurities | | dietary supplements. |
| | | in the | | |
| | | retention | | |
| | | time. | | |
| | Oxidation | There is | Pass | |
| | | degradation of | | |
| | | the standard | | |
| | | and sample, | | |
| | | and no change | | |
| | | in retention | | |
| | | time was | | |
| | | observed. | | |
| | Photolysis | There is | Pass | |
| | | degradation of | | |
| | | the standard | | |
| | | and sample, | | |
| | | but there are | | |
| | | no impurities | | |
| | | in the | | |
| | | retention | | |
| | | time. | | |
| | Pyrolysis | There is no | Pass | |
| | | degradation of | | |
| | | the standard | | |
| | | and sample, | | |
| | | and no change | | |
| | | in retention | | |
| | | time was | | |
| | | observed. | | |
| System | 5.59 ≤ RT ≤ | 5.6388 | Pass | The HPLC equipment |
| Suitability | 5.89 | | | used for validating |
| | 0.8 ≤ T ≤ 1.5 | 1.351 | Pass | this analytical |
| | N > 2500 | 2761.8 | Pass | method meets the |
| | % RSD ≤ 2.00 | 0.4721 | Pass | technical |
| | | | | requirements to be |
| | | | | able to detect and |
| | | | | quantify fucoxanthin |
| | | | | in raw materials and |
| | | | | dietary supplements |
| | | | | with % RSD = 0.4721. |
| | | | | Fucoxanthin can be |
| | | | | detected at 5.59-5.89 |
| | | | | minutes (5%) |
| | | | | with tailing factor |
| | | | | equal to 1.351, |
| | | | | ensuring efficiency |
| | | | | in the detection of |
| | | | | the analyte. |
| Linearity | Equation | y = | N/A | The system works |
| | | 154351x − 63683.9 | | properly to detect |
| | R² > 0.99 | 0.996 | Pass | fucoxanthin using a |
| | % RSD | 1.5223 | Pass | 5-point calibration |
| | | 0.1966 | Pass | curve from the |
| | | 0.3934 | Pass | lowest to the |
| | | 0.1312 | Pass | highest |
| | | 0.533 | Pass | concentration tested |
| | Concentration | 50%-120% | Pass | on this method whit |
| | 70%-130% | | | 99.3% exactitude |
| | | For content | | using Fucoxanthin |
| | | uniformity | | Reference Standard |
| | | | | (92.8% purity |
| | | | | declared in CoA). |
| LOQ | N/A | 0.6 μg/mL | N/A | Using this method, up to |
| LOD | N/A | 0.2 μg/mL | N/A | 0.6 μg/mL |
| | | | | of fucoxanthin |
| | | | | can be quantified and up |
| | | | | to 0.2 μg/mL of |
| | | | | fucoxanthin can be |
| | | | | detected with 99.3% |
| | | | | accuracy. |
| Range | Equation | y = | N/A | This method can be used |
| | | 0.003 − 133084 | | to quantify fucoxanthin |
| | R² > 0.99 | 0.995 | Pass | in a range of |
| | % RSD | 0.6745 | Pass | concentrations from 50% |
| | | 0.4140 | Pass | to 150% in raw materials |
| | | 0.0299 | Pass | and dietary supplements |
| | Recovery | 92.23% | Pass | with 99.5% accuracy. |
| | 70%-130% | 98.09% | Pass | |
| | | 109.40% | Pass | |
| Accuracy | Equation | y = | N/A | Using spiked samples |
| | | 19.8325x − 0.0004 | | with known concentration |
| | R² > 0.99 | 0.998 | Pass | of fucoxanthin, this |
| | % RSD | 1.2045 | Pass | method can detect and |
| | | 1.8847 | Pass | quantify fucoxanthin |
| | | 1.0710 | Pass | between 50% to 150% of |
| | Recovery | 93.24% | Pass | the content in any raw |
| | 50%-150% | 118.963% | Pass | material and dietary |
| | | 101.80% | Pass | supplement with 99.8% |
| | | | | accuracy. |
| Precision | Intra- | 0.92% | Pass | The method demonstrated |
| | Laboratory | | | to be precise when run |
| | Inter-day | 1.24% | Pass | in different days and by |
| | | | | different analysts. |

In the fucoxanthin method validation as shown in Table 1 above, the selectivity referred to the method's ability to differentiate and measure fucoxanthin in the presence of other compounds. Specificity ensured that the method only detected fucoxanthin and no other similar substances. In selectivity validation, the method differentiated and measured the fucoxanthin in the presence of other components in the sample's complex matrix. This can also be evaluated by analyzing blank samples from different sources to assess the presence of interfering substances. The interference may be considered acceptable if the response is less than 20% of the lower limit of quantification (LLOQ) for the fucoxanthin and 5% for an internal standard (IS) as an example.

The specificity referred to the ability of the method to specifically separate and quantify the fucoxanthin in the presence of other components, including potential inorganic or organic impurities. Specificity may be divided into two parts; a) matrix interference, and b) separation selectivity. The matrix interference checked for enhancing or quenching effects of the sample matrix. The separation selectivity assessed the method's ability to separate fucoxanthin from other potential interfering substances. In the HPLC process, the method may separate a sample spiked with known amounts of potentially interfering substances. Samples that are subjected to stress, e.g., forced degradation studies, may be suitable for evaluating Separation selectivity.

The ICH (International Council for Harmonisation) guidelines define specificity as the ability of the method to specifically separate the particular API or analyte, such as fucoxanthin, in the presence of other components. ICH guidelines also note that selectivity is the ability of an analytical method to differentiate and measure the analyte in the presence of potential interfering substances in the blank biological matrix.

In the context of fucoxanthin analysis, the system suitability tests ensure that the HPLC system functions correctly and delivers reliable data by verifying the HPLC parameters, such as the peak shape, the resolution, and retention time reproducibility. When analyzing fucoxanthin, especially using HPLC, it is crucial to validate the analytical method and ensure its accuracy, precision, and reliability.

There are some system suitability tests that assess the performance of the HPLC system before running samples. These were applied before experiments were run. Different parameters were checked, such as the peak shape, which ensured the peak is symmetrical and well-defined, indicating good chromatographic separation. The resolution verified that fucoxanthin and other compounds of interest were adequately separated, preventing co-elution. The retention time reproducibility checked that the retention time of fucoxanthin was consistent across multiple injections, ensuring accurate quantification. It was possible to incorporate theoretical plates (N) that operate as a measure for the efficiency of the chromatographic column, indicating the degree of achieved separation. The tailing factor operated as a measure of peak asymmetry, indicating the shape of the peak.

Internal standards, such as neoxanthin, astaxanthin or other suitable carotenoids, may improve the accuracy and precision of the analysis, helping to ensure that the HPLC system performed optimally, leading to reliable and accurate fucoxanthin quantification. Different aspects may be optimized, such as the mobile phase that may include acetonitrile and methanol and other components, and the flow rate for efficient separation of fucoxanthin. A C18 column was chosen for optimal separation, and the fucoxanthin concentration was rapidly determined using spectrophotometry at specific wavelengths, e.g., 663 nm, 445 nm, 750 nm, and more particularly, 450 nm. It is possible that optimized extraction techniques may include in addition to those used and described herein deep eutectic solvents (DESs) or conventional solvents such as methanol and/or ethanol as described herein.

In the fucoxanthin method validation shown and described in Table 1 above, the linearity referred to the ability of the analytical procedure as described to provide the test results directly proportional to the concentration of fucoxanthin within a specific range. This was assessed by creating a calibration curve and analyzing its R-squared value. With linearity, the response of the analytical method, e.g., a peak area in HPLC, absorbance, etc., increased or decreased proportionally to the concentration of the fucoxanthin within a defined range. Linearity was assessed in various ways, including with the calibration curve as described herein that may be created by plotting the analytical response, e.g., peak area, against known concentrations of fucoxanthin standards. In a linear regression, the linearity was determined by performing a linear regression analysis on the calibration curve data. The Rsquared value as the coefficient of determination indicated how well the data points fit the linear model. A higher R-squared value, e.g., close to 1, indicated better linearity. Ensuring linearity was important for accurate and reliable quantification of fucoxanthin in disparate samples.

Different factors, such as the extraction efficiency, instrumental conditions, and the sample matrix, impacted linearity, requiring careful optimization and validation to ensure accurate and reliable results. The techniques used for extraction was important. For example, the choice of solvent, such as ethanol, methanol, and/or acetone, and any concentration of solvents, influenced fucoxanthin extraction efficiency, potentially leading to non-linear responses if the extraction was not complete or consistent. Inadequate extraction time or temperature may result in incomplete extraction, while excessive conditions may lead to fucoxanthin degradation, both affecting the linearity of the calibration curve. The presence of interfering compounds in the sample matrix, such as other carotenoids, pigments, lipids, and/or chemical components, may affect the detection of fucoxanthin and potentially lead to non-linear responses.

The instrument conditions such as HPLC Parameters affected results. The mobile phase composition, its flow rate, and column temperature affected the separation and detection of fucoxanthin during the HPLC analysis, influencing the linearity of the calibration curve. The type of detection was important, for example, the detector, e.g., UV-Vis, photodiode array, and its response to fucoxanthin, may not be linear across the entire concentration range, requiring careful calibration and validation.

Sample preparation was important. For example, improper dilution of samples can lead to matrix effects and non-linear responses, especially when using internal standards. Fucoxanthin is known to be unstable and degrade over time, especially when exposed to light or heat. Proper storage conditions, e.g., dark, cold storage, was crucial to maintain linearity. The calibration curve was also important. The linearity of the calibration curve was evaluated over a relevant concentration range that included the expected fucoxanthin concentrations in the samples. Linear regression analysis was used to determine the linearity of the calibration curve, and the coefficient of determination (R2) was high to indicate good linearity.

Thus, to ensure linearity during the fucoxanthin method validation, the extraction conditions had to be optimized and a robust and efficient extraction method used to ensure complete and consistent recovery of fucoxanthin. Instrument parameters were controlled to optimize HPLC conditions and achieve good separation and detection of fucoxanthin. Appropriate calibration standards were used to prepare the calibration standards in a matrix similar to the samples to minimize matrix effects. It was important to evaluate linearity and assess the linearity of the calibration curve over the relevant concentration range and ensure a high R2 value.

In the fucoxanthin method validation, the Limit of Quantification (LOQ) was the lowest concentration of fucoxanthin that was reliably and accurately measured. In an example, it was defined as the concentration where the signal-to-noise ratio is 10 or higher, ensuring a precision and trueness that met the analytical goals. The LOQ may also represent the lowest concentration of fucoxanthin that can be quantified with a defined level of accuracy and precision. The LOQ helped determine the sensitivity of the analytical method and ensured that the method reliably detected and quantified fucoxanthin at relevant concentrations. In an example, LOQ was determined by establishing a calibration curve using known concentrations of fucoxanthin, and then identifying the lowest concentration where the signal was significantly above the baseline noise, for example, a signal-to-noise ratio of 10 or higher.

The LOQ may be influenced by factors such as the type of analytical method, e.g., HPLC, spectrophotometry, LC-MS, the instrument's performance, and the sample matrix. As a non-limiting example, there was a relationship to the Limit of Detection (LOD). The LOQ was typically higher than the LOD, which was the lowest concentration that could be reliably detected, but not necessarily quantified. The Lower Limit of Quantification (LLOQ) for fucoxanthin may be defined in ng/ml, based on a signal-to-noise ratio (S/N) of 10 as an example.

The calibration curve was created by plotting known concentrations of fucoxanthin against an instrument's response, e.g., peak area in HPLC (or absorbance in spectrophotometry in other examples). The LOQ was defined in an example as the concentration at which the signal is 10 times greater than the noise, e.g., background signal. The LOQ should be able to provide results with acceptable accuracy, such as how close the measured value is to the true value, and precision, such as how close repeated measurements are to each other. The LOQ may be mathematically calculated using the standard deviation of the response (o) and the slope(S) of the calibration curve, using the formula: LOQ=10σ/S.

In the method validation for fucoxanthin analysis, the limit of detection (LOD) in an example was the lowest concentration of fucoxanthin that could be reliably distinguished from the background noise, such as the concentration where the signal-to-noise ratio (S/N) is 3:1, as an example. The limit of detection (LOD) may be the lowest concentration of a substance that can be reliably detected by the specific analytical method. Knowing the LOD helped in method validation because it determined the lowest concentration of fucoxanthin that the method can accurately measure. Linear regression analysis was used in an example to determine the LOD based on the slope and intercept of the calibration curve. As an example, if a method had an LOD of 0.01 μg/mL, it could reliably detect fucoxanthin at concentrations of 0.01 μg/mL or higher, but may not be able to accurately measure concentrations below that level.

The fucoxanthin method validation for range referred to the concentration range that demonstrated linearity, accuracy, and precision. This range ensured the method was reliable and provided accurate results within the expected fucoxanthin levels. The method showed a linear relationship between the fucoxanthin concentration and the measured signal, e.g., absorbance or peak area, across the validation range. This was typically assessed by plotting the calibration curve and evaluating the R-squared value as a measure of how well the data fits a straight line. The method provided results that are close to the true fucoxanthin concentration within the validation range.

Accuracy was often assessed using reference standards or certified reference materials. The method produced consistent and reproducible results when analyzing the same sample multiple times within the validation range. Precision was assessed by calculating the relative standard deviation (RSD) or coefficient of variation (CV). The validation range encompassed the expected fucoxanthin concentrations in the samples being analyzed. For example, when analyzing fucoxanthin in seaweed samples, the validation range may be from about 1 to 10 mg/g of dry weight. Validation became a key requirement in ensuring the reliability and suitability of an analytical method and it was performed according to guidelines from regulatory agencies.

The accurate quantification of fucoxanthin is necessary for research, quality control in food and dietary supplement industries, and understanding its biological effects. The method validation as described ensured that the analytical method used for fucoxanthin determination is reliable and provides accurate results.

The method produced a linear response over the expected concentration range of fucoxanthin using the method as described. This was assessed by analyzing a series of standard solutions with known concentrations and plotting the results. The method provided precision with consistent and reproducible results when analyzing the same sample multiple times as assessed by analyzing replicate samples and calculating the relative standard deviation (RSD) or coefficient of variation (CV). The method provided results that were close to the true value of the fucoxanthin concentration, which was assessed by analyzing samples with the known concentrations, e.g., spiked samples, and comparing the measured values to the known values.

Accuracy also referred to how close the measured value is to the true or theoretical value. In the context of fucoxanthin analysis, this meant ensuring that the method accurately quantified the amount of fucoxanthin present in the sample. For example, there may be multiple determinations where accuracy is assessed using a minimum of nine (9) determinations over a minimum of three (3) concentration levels covering the specified range. Multiple replicates, e.g., three (3) replicates, may be run of samples at different concentrations within the range of interest. The results from these determinations may then be compared to the known or true value of the fucoxanthin concentration to assess the accuracy of the method.

In the fucoxanthin method validation, the precision referred to reproducibility or closeness of agreement among repeated measurements of a homogeneous sample, typically assessed through repeatability, intermediate precision, and reproducibility, indicating how closely repeated measurements of the same sample agree with each other. This assesses the precision within a single laboratory, performed by the same analyst or group using the same equipment and method on the same day. Intermediate precision referred to the precision between different laboratories, analysts, or equipment, or even different days. Reproducibility measured the precision between different laboratories, analysts, and equipment.

When validating the method for fucoxanthin analysis, the precision was important to ensure that the results were reliable and consistent.

Referring to Table 2 shown below, the experimental design used to determine the best conditions for fucoxanthin extraction is illustrated. The design of experiments was carried out based on a Plackett-Burman matrix. A sequence of vortex-assisted-extraction using a methanolic extract was employed, followed by ultrasonic extraction and buffer stabilization. This inventive process with its parameters as described was found to be optimum conditions in one example for fucoxanthin recovery from complex matrice.

To design experiments for fucoxanthin extraction using a Plackett-Burman matrix, it was necessary to first identify the factors affecting extraction (e.g., solvent, temperature, time) and their levels. Then a Plackett-Burman design was used to efficiently screen these factors in a limited number of experiments, focusing on main effects while acknowledging potential interaction effects.

When Plackett-Burman was applied to fucoxanthin extraction, various factors were identified that may affect fucoxanthin extraction, such as the solvent type, e.g., methanol, ethanol, and/or acetone, the extraction temperature, the extraction time, the solvent-to-algae ratio when algae samples were used, the sonication time when using ultrasonic extraction, particle size, and the extraction technique, such as the determined vortexing, ultrasonic extraction and buffering.

The high and low levels for each factor were determined and an appropriate Plackett-Burman design selected based on the number of factors to screen and the experimental design matrix. The experiments were run according to the design matrix and the fucoxanthin yield or other relevant response recorded for each run. The data was analyzed and the factors identified that had a significant impact on fucoxanthin extraction with the individual impact of each factor. The extraction process was optimized.

In vortex extraction, the vortex mixer enhanced solid-liquid extraction, improving the efficiency of fucoxanthin extraction from the sample, such as a biomass or other sample. The methanol was an organic solvent, effectively dissolving the fucoxanthin for extraction purposes. The ultrasonic waves further enhanced the extraction process by disrupting cell walls and facilitating the release of fucoxanthin. The buffer stabilization with a buffer solution stabilized the extracted fucoxanthin solution, preventing degradation and maintaining its bioactivity.

TABLE 2
Experimental Conditions for Fucoxanthin Extraction

| | | | | | Vortex- | Heat |
|---|---|---|---|---|---|---|
| | Methanol | Acetonitrile | Buffer | Ultrasonic | Assisted | Assisted |
| Experiment | Extraction | Extraction | Extraction | Extraction | Extraction | Extraction |
| 1 | + | + | + | + | + | + |
| 2 | + | − | − | + | + | − |
| 3 | − | + | − | − | + | + |
| 4 | − | − | + | − | + | − |
| 5 | − | + | + | + | − | − |
| 6 | + | − | + | − | − | + |
| 7 | + | − | − | + | + | − |

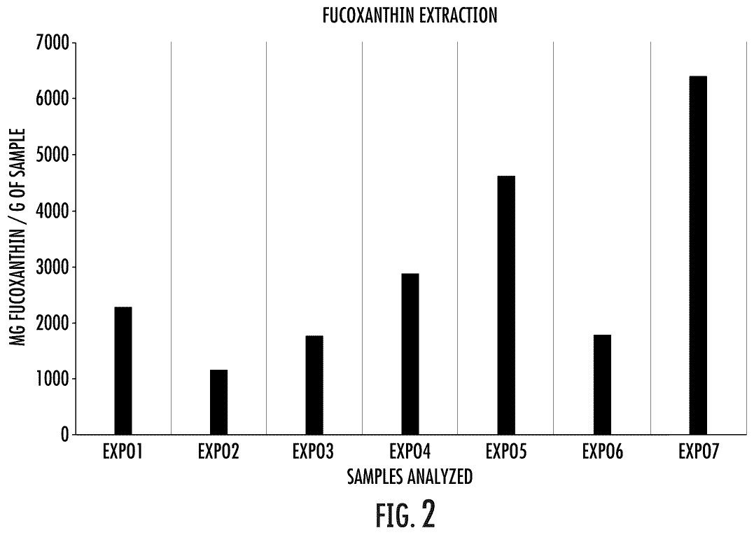

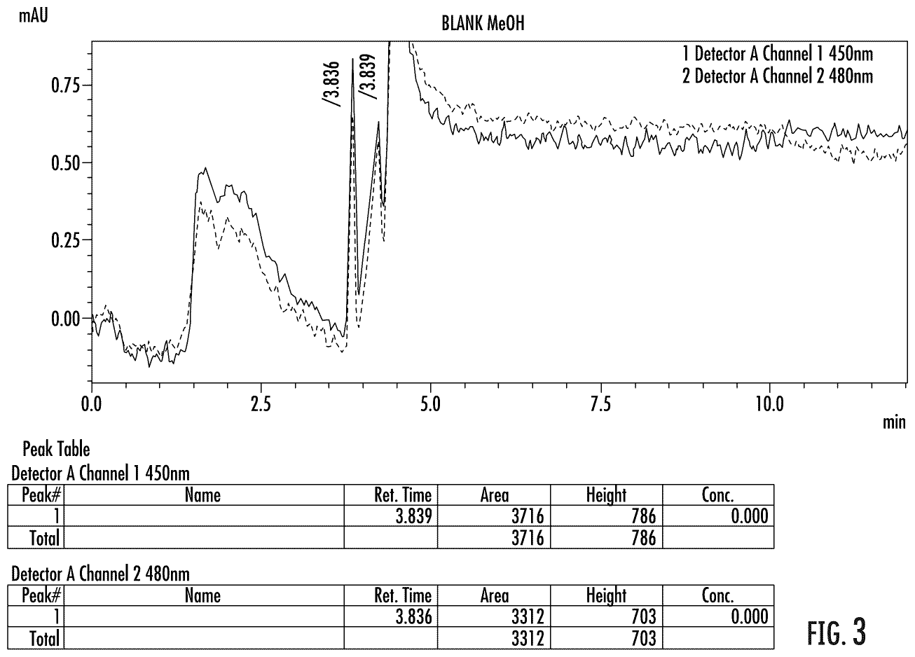

FIG. 2 shows a bar chart of the samples analyzed for fucoxanthin extraction compared with the amount of fucoxanthin in milligrams per gram of sample.

Referring to Table 3 below, some of the chromatographic parameters that were investigated to achieve the inventive fucoxanthin separation using a C18 column are shown. An individual standard solution of fucoxanthin (5 μg/mL) was used to identify retention time (RT) and peak chromatographic parameters. Initial conditions were adapted from known sources. Samples containing fucoxanthin, such as marketed under the tradename Fucopure from Nutraceuticals Group of Little Falls, New Jersey, and added spirulina and chlorella, were investigated to confirm that the method was able to separate/identify fucoxanthin in the complex matrices.

In the HPLC analysis, a 5 μg/mL solution of fucoxanthin was used to identify its retention time and other peak chromatographic parameters, such as peak shape, area, and width. The HPLC (High-Performance Liquid Chromatography) system separated and identified compounds based on their different affinities for the mobile and stationary phase. The 5 μg/mL solution of fucoxanthin was used as the standard for identifying and quantifying fucoxanthin in the samples. By running the standard solution through the HPLC system, it was possible to determine its retention time and other peak chromatographic parameters, which were used to identify fucoxanthin in the unknown samples.

The retention time and peak parameters were important in the analysis. Retention time was the time it took for the compound of interest to travel through the HPLC column and elute, e.g., be detected. Factors that were analyzed included the peak shape as the shape of the peak in the chromatogram, which indicated the efficiency of the separation. The peak area corresponded to the area under the peak, which was proportional to the concentration of the compound. The peak width was the width of the peak, which indicated the resolution of the separation. The retention time in the inventive process as explained was used as a reference for identifying fucoxanthin in other samples.

The selection of proper mobile phase and its combination, together with other HPLC parameters was important. The C18 column with the specific methanol and acetonitrile, together with other HPLC parameters was used for fucoxanthin analysis in the reversed-phase chromatography because these solvents, particularly acetonitrile, offered a good balance of elution strength. Ultraviolet transparency and compatibility with the column and the target compound as fucoxanthin. Fucoxanthin is a relatively non-polar compound and was found to be best separated using the reversed-phase chromatography process, where the C-18 stationary phase was non-polar and the mobile phase, i.e., specific combination of methanol and acetonitrile was more polar and with the particular HPLC parameters.

Methanol is a protic solvent, but can lead to peak tailing and can cause higher column pressure. Acetonitrile is a aprotic solvent and has lower viscosity, higher elution strength, and a broader ultraviolet absorption spectrum, leading to faster analyses and better ultraviolet detection. The method achieves the proper balance between methanol and acetonitrile and other factors as described.

TABLE 3
Experimental Conditions for Chromatographic Analysis

| | Mobile | Mobile | |
|---|---|---|---|
| Experiment | phase A | phase B | Comments |
| 1 | H₂O | MeOH | λ₁ = 450 nm, λ₂ = 480 nm; Isocratic, run time |
| | | | 15 min; Column Temperature = 30 °C; Flow |
| | | | rate = 1 mL/min; Injection volume = 20 μL |
| 2 | H₂O | MeCN | λ₁ = 450 nm, λ₂ = 480 nm; Isocratic, run time |
| | | | 15 min; Column Temperature = 30 °C; Flow |
| | | | rate = 1 mL/min; Injection volume = 20 μL |
| 3 | MeOH | MeCN | λ₁ = 450 nm, λ₂ = 480 nm; Isocratic, run time |
| | | | 15 min; Column Temperature = 30 °C; Flow |
| | | | rate = 1 mL/min; Injection volume = 20 μL |
| 4 | CHCl₃ | ACN | λ₁ = 450 nm, λ₂ = 480 nm; Isocratic, run time |
| | | | 15 min; Column Temperature = 30 °C; Flow |
| | | | rate = 1 mL/min; Injection volume = 20 μL |
| 5 | ACN:H₂O | | λ₁ = 450 nm, λ₂ = 480 nm; Isocratic, run time |
| | (5:95, | | 25 min; Column Temperature = 30 °C; Flow |
| | v/v) | | rate = 1 mL/min; Injection volume = 20 μL |
| 6 | MeOH | ACN | λ₁ = 450 nm, λ₂ = 480 nm; Isocratic, run time |
| | | | 15 min; Column Temperature = 30 °C; Flow |
| | | | rate = 0.75 mL/min; Injection volume = 20 μL |
| 7 | H₂KPO₄ | MeOH | λ₁ = 450 nm, λ₂ = 480 nm; Isocratic, run time |
| | | | 15 min; Column Temperature = 30 °C; Flow |
| | | | rate = 0.75 mL/min; Injection volume = 20 μL |

An example procedure for preparing a sample in accordance with the method and its analysis to determine fucoxanthin content is now described.

An amount of finely powdered sample equivalent to 400-600 μg of fucoxanthin was accurately weighed and transferred to a 50-mL flask. About 30-35 milliliters (mL) of methanol was added and vortexed for about 2 to about 3 minutes. This test sample was placed in an ultrasonic bath and sonicated for about 10 minutes at about 40 °C. The test solution was cooled at room temperature and the volumetric flask was filled to volume with about 20 mM H₂KPO₄ at about pH 7.20±0.05. It was mixed well and the sample sonicated for about 10 minutes at about 40 °C. The test solution was cooled to about room temperature and homogenized. With some samples, it was found necessary to centrifuge the solution at about 500 rpm for about 5 minutes to remove large particles.

The test solution was filtered through a 0.45 μm Nylon filter and injected to the chromatograph. By reducing the sample material to a fine powder, the extraction efficiency was enhanced because the increased surface area facilitated more effective solvent penetration and mass transfer, thereby allowing for a more complete release of fucoxanthin from the complex matrices. Methanol's polarity, hydrogen-bonding capacity, and relatively small molecular size was found to make it particularly effective at extracting fucoxanthin, since it is a xanthophyll characterized by multiple polar functional groups, such as hydroxyl and epoxide moieties. These functional groups increase fucoxanthin's polarity, allowing it to readily interact with methanol's polar hydroxyl group. In turn, methanol's ability to form hydrogen bonds and stabilize polar molecules ensured efficient solubilization of fucoxanthin.

Ultrasonic treatment was coupled with moderate heating to improve extraction from the complex matrices by simultaneously disrupting cellular structures and enhancing solvent interactions. The high-frequency sound waves generated during ultrasonication created intense shear forces and micro-cavitation events, effectively breaking down cell walls and membranes. This increased the accessibility of intracellular compounds, making them more readily available to the surrounding solvent. At the same time, moderate heat lowered the solvent's viscosity and increased both the solubility and diffusion rates of target molecules. As a result, the combined effect of ultrasonic agitation and gentle warming significantly accelerated mass transfer and lead to higher extraction efficiencies, shorter processing times, and more complete recovery of the bioactive compounds from any algal biomass or other sample material.

Because fucoxanthin, more so than many other carotenoids, was prone to excessive degradation under strongly acidic or alkaline conditions, as well as in the presence of oxidative stress, it was found advantageous to maintain a near-neutral pH environment with a well-buffered system to reduce the risk of acid- or base-catalyzed structural changes and mitigate the potential for oxidation. In this stable chemical milieu, fucoxanthin's sensitive epoxide and hydroxyl functional groups were less likely to be disrupted, thereby preserving its molecular integrity and prolonging its shelf life. An example of the chromatographic analysis parameters is shown in Table 4 below.

TABLE 4

| Parameter | Comments | |
|---|---|---|
| Injection Volume | 10 | μL |
| Mobile Phase | MeOH:MecN (70:30); 1-15 | |
| | min [Isocratic] | |
| Flow Rate | 0.75 | mL/min |
| Column | Nucleosil ® C18, 4.6 × 150 | |
| | mm, 5 μm | |
| Column Temperature | 28 | °C |
| Detection | 450 | nm |

In a non-limiting example, the amount of fucoxanthin in the sample was calculated as follows:

$$fx [ mg / g ] = \frac{( \frac{b - {r}_{fx}}{m} ) ( \frac{V}{w} ) ( D )}{1000} \qquad Eq . 1$$

$$fx [ \% ] = \frac{( \frac{b - {r}_{fx}}{m} ) ( \frac{V}{w} ) ( D )}{10000} \qquad Eq . 2$$

Where:
b: Intercept, from fucoxanthin calibration curve;
m: Slope, from fucoxanthin calibration curve; and
r_{fx}: response of the peak corresponding to fucoxanthin in the sample (test solution) chromatogram.

The method of the current invention was applied to numerous test samples with consistency, and was found to provide a robust high-performance liquid chromatography (HPLC) method that was developed and validated for the quantitative determination of fucoxanthin in a supplement known under the tradename Fucopure, and other dietary supplements containing Fucopure, and many samples containing fucoxanthin. The method utilized the C18 stationary phase and an isocratic mobile phase that was methanol:acetonitrile (70:30, v/v) at a flow rate of 0.75 mb/min in a non-limiting example with VIS detection at a wavelength of 450 nm. Extraction of Fucoxanthin was achieved by sequential steps of vortex-assisted-extraction, ultrasonication and addition of a buffer that stabilized the extract to prevent its degradation.

There were different validation parameters, including specificity, linearity, accuracy, precision, limit of detection (LOD), and limit of quantitation (LOQ), which were assessed following the International Conference on Harmonisation (ICH) guidelines. The method demonstrated excellent linearity over the concentration range of 1.0-20 μg/mb with a correlation coefficient (R²) greater than 0.995. Intra- and inter-day precision values were below 2% RSD, and recovery rates were within 98-100%. The LOD and LOQ were determined to be 0.2 μg/mL and 0.6 μg/mb, respectively in various examples. This validated HPLC method was rapid, accurate and reliable, making it suitable for routine quality control and analysis of fucoxanthin in Fucopure and other products.

Different chromatographic systems may be used to achieve identification of fucoxanthin. An example of the chromatographic system used to obtain the described results is shown in Table 5.

TABLE 5

| DEGASSER UNIT | PROMINENCE DGU-20A5 |
|---|---|
| PUMP (×2) | Prominence LC-20AT |
| AUTOSAMPLER | Prominence SIL-20A HT |
| COLUMN OVEN | Prominence CTO-20AC |
| DETECTOR | Prominence SPD-20A UV/VIS |
| | Detector |
| COMMUNICATIONS | CBM-20A |
| MODULE | |

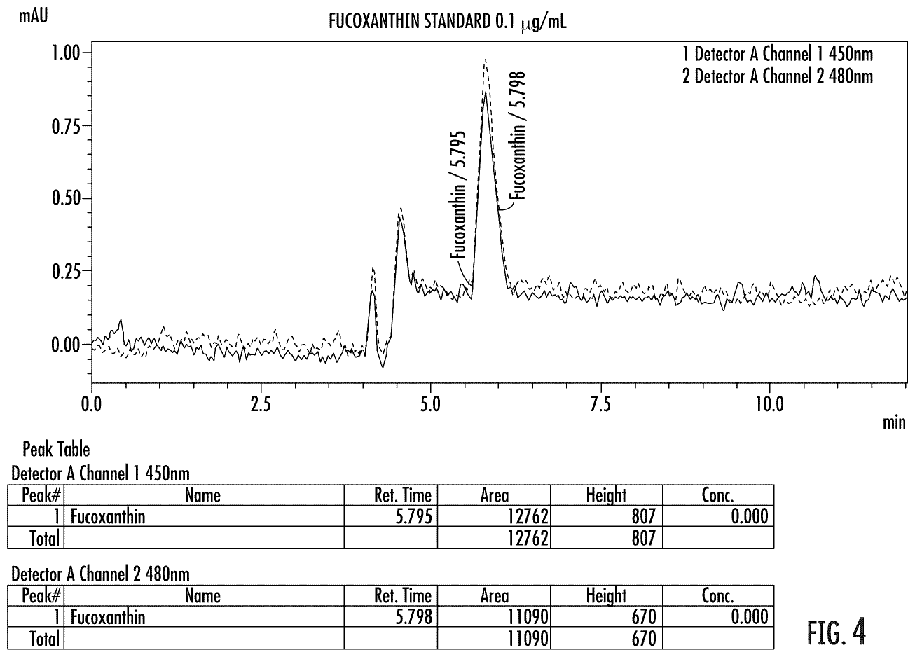

Referring now to FIGS. 3-10, there are illustrated example chromatograms that show that fucoxanthin was effectively identified and quantitated in different samples containing fucoxanthin, such as Fucopure by HPLC-UV after extraction by the validated protocol. The retention time of the peak for fucoxanthin matched the retention time and chromatographic characteristics of a reference material for fucoxanthin. The results of the method validation showed that the method was accurate, precise, reproducible, and was cost effectively applied across numerous samples of different origin.

FIG. 3 is a chromatogram and associated peak table for a blank injection made to demonstrate that solvents used during the analysis did not interfere with the fucoxanthin detection.

FIG. 4 is a chromatogram and associated peak table for an injection of fucoxanthin RS (Reference Standard) at a low concentration to determine the Limit of Detection (LOD) and Limit of Quantification (LOQ).

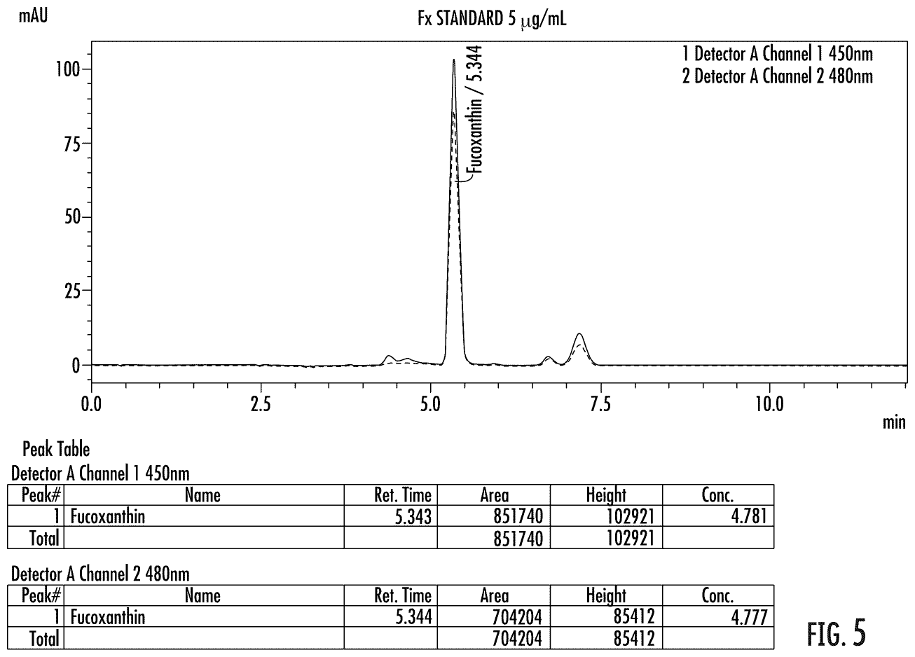

FIG. 5 is a chromatogram and associated peak table for an injection of fucoxanthin RS at the lowest level of the calibration curve.

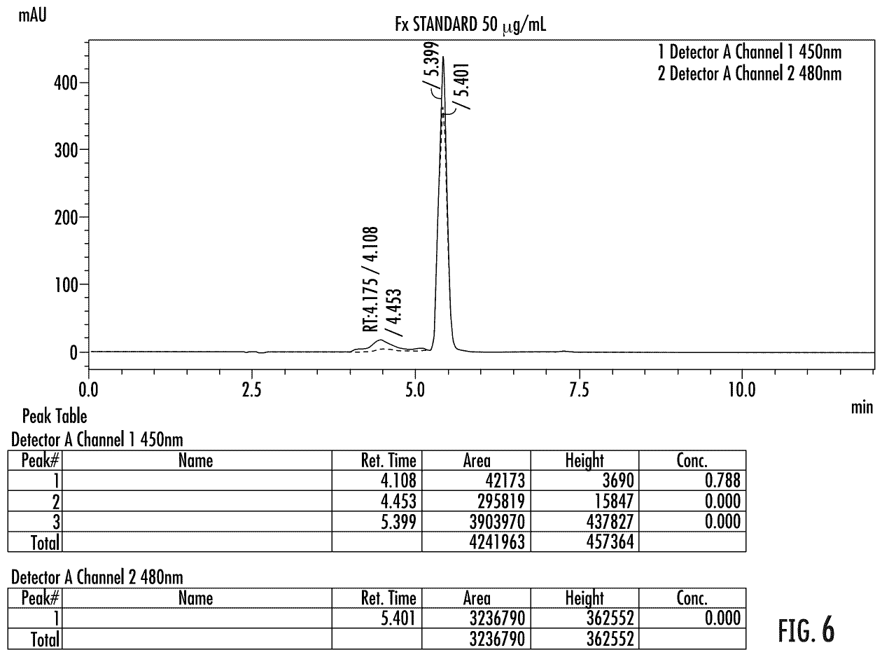

FIG. 6 is a chromatogram and associated peak table for an injection of fucoxanthin RS at the highest level of the calibration curve.

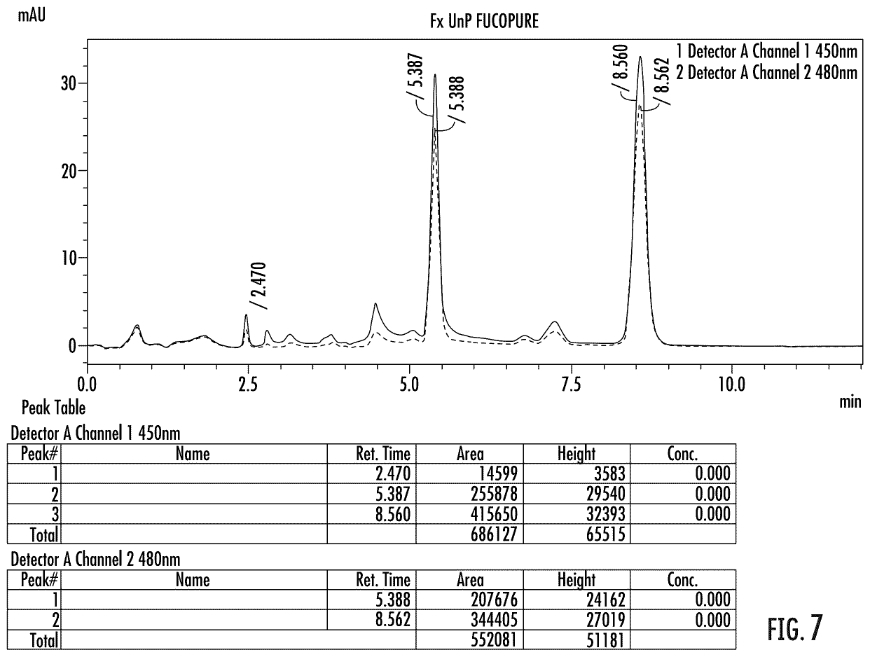

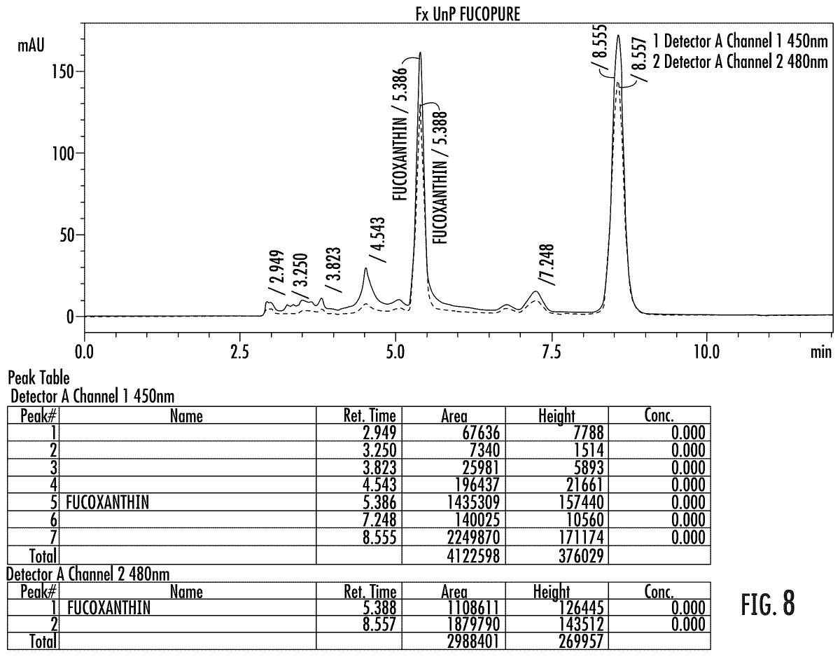

FIG. 7 is a chromatogram and associated peak table for an injection of Fucopure after extraction was performed using the protocol as designed and as described in the methodology. The injection was made at a low concentration to determine the range of the method and the concentration of fucoxanthin in the sample where the method was validated.

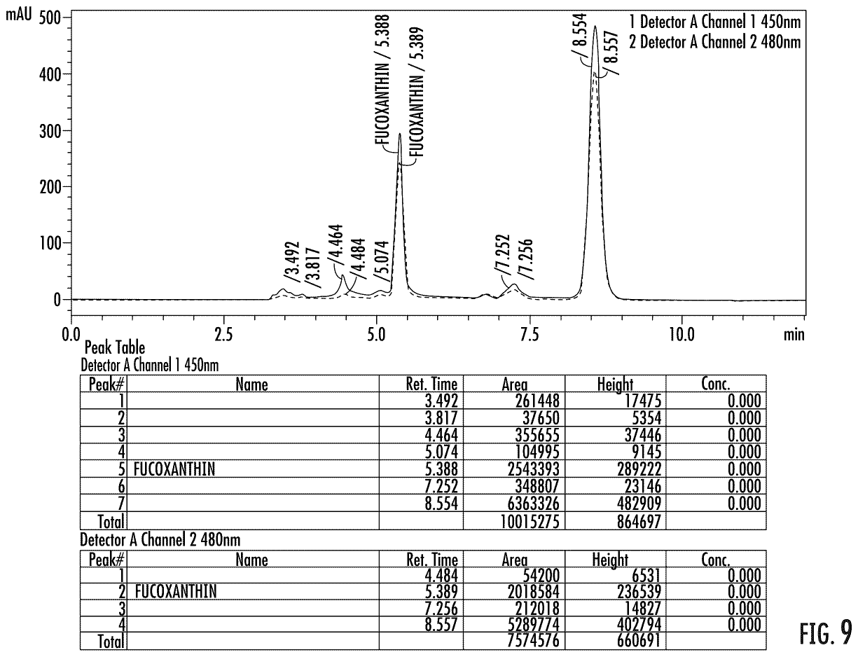

FIG. 8 is a chromatogram and associated peak table for an injection of Fucopure after extraction was performed using the protocol as designed and as described in the methodology. The injection was made at a medium concentration to determine the range of the method and the concentration of fucoxanthin in sample where the method was validated.

FIG. 9 is a chromatogram and associated peak table for an injection of Fucopure after extraction was performed using the protocol as designed and as described in the methodology. The injection was made at a high concentration to determine the range of the method and the concentration of fucoxanthin in the sample where the method was validated.

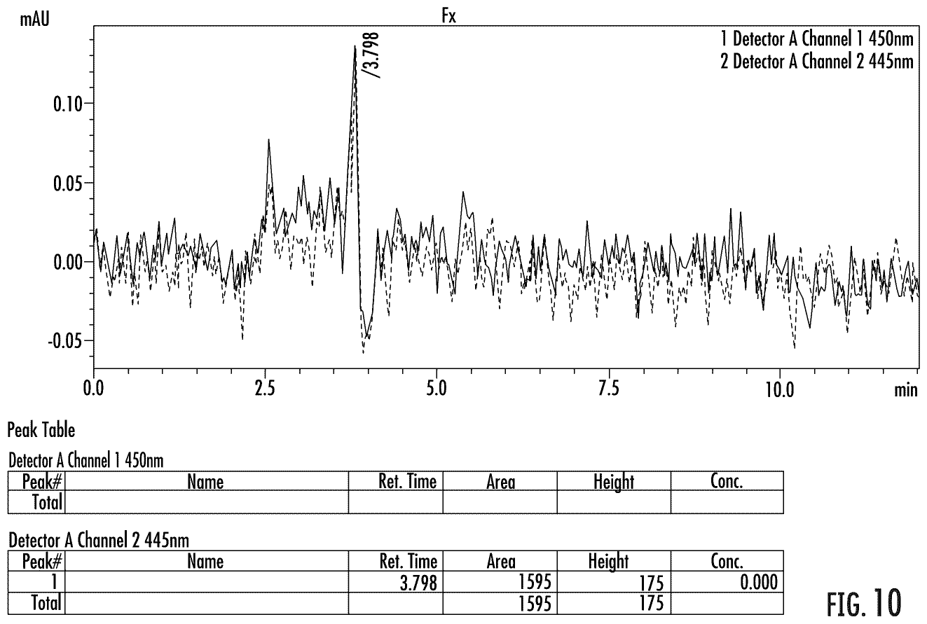

FIG. 10 is a chromatogram and associated peak table for an injection of sample material that was similar to Fucopure, i.e., an algae extract without fucoxanthin to demonstrate the accuracy of the validated method. It was apparent that no other compounds interfered with the analysis.

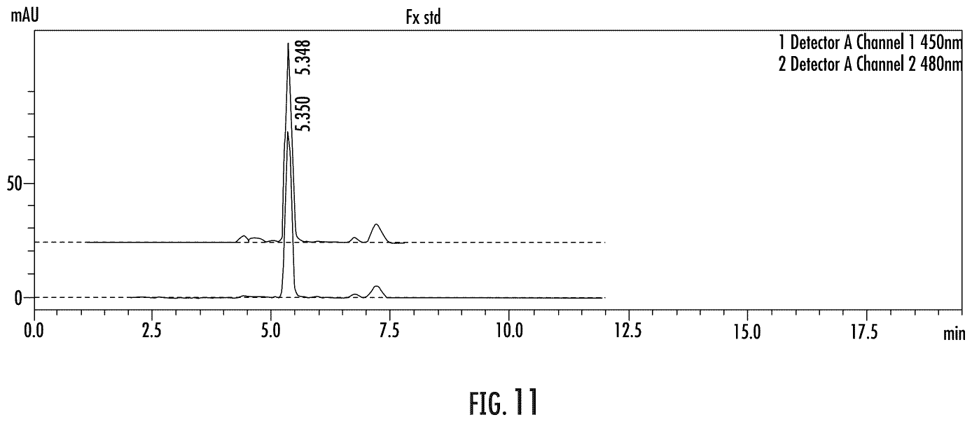

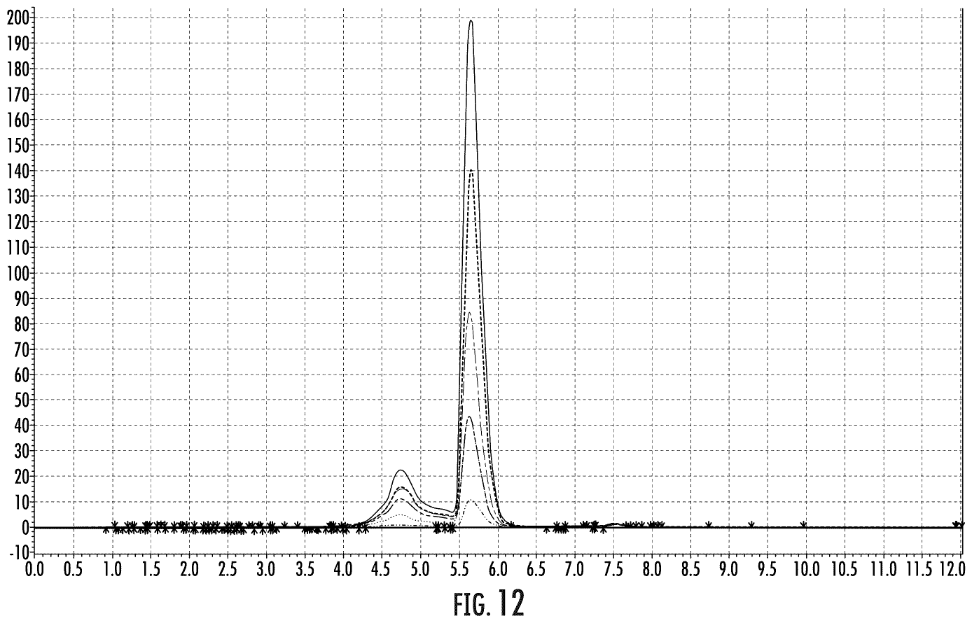

FIGS. 11 and 12 show overlaid chromatograms for a fucoxanthin reference standard (92.8% purity CAS: 3351-86-8; LOT: 00006296-941; ChromaDex, CA, USA) from 1 to 20 μg/mL was analyzed.

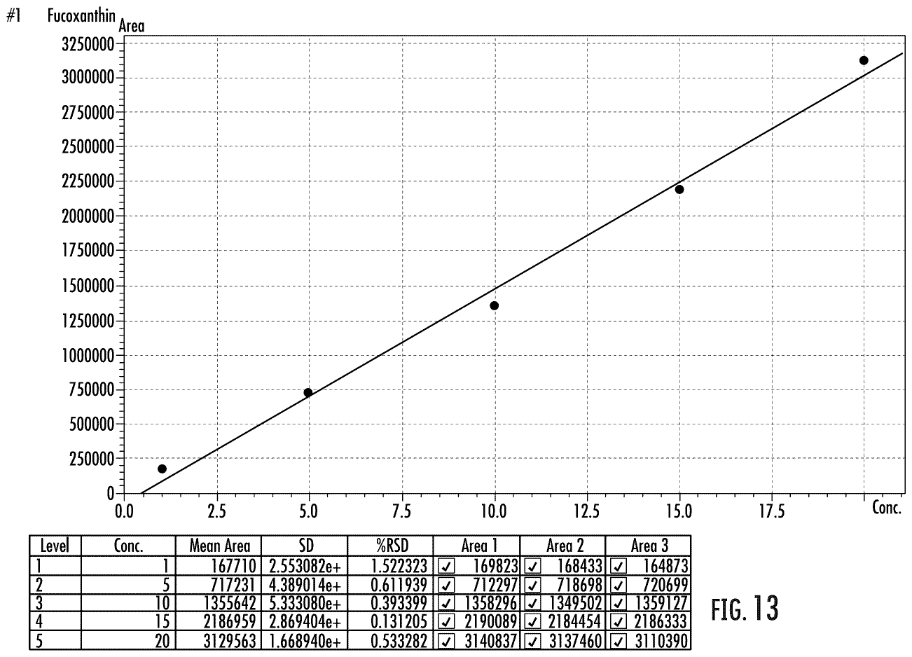

FIG. 13 is a graph for a linear regression for a calibration curve for a fucoxanthin reference standard (92.8% purity CAS: 3351-86-8; LOT: 00006296-941; ChromaDex, CA, USA), where from 1 to 20 μg/mL was analyzed, and showing in the associated table the results at different concentrations and standard deviation, RSD and areas. The concentrations ranged from 1.0 to 20.0 μg/mL.

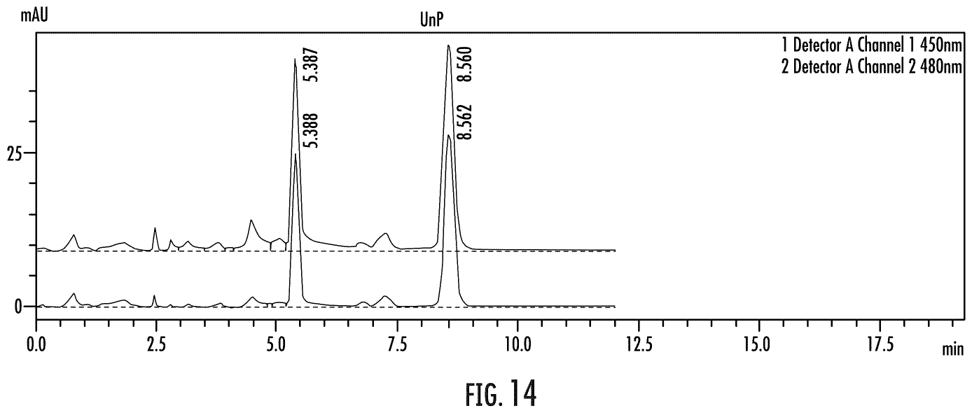

FIG. 14 is a chromatogram that shows an overlay of fucoxanthin detected in a sample of Fucopure. A typical peak was detected at 5.4 min.

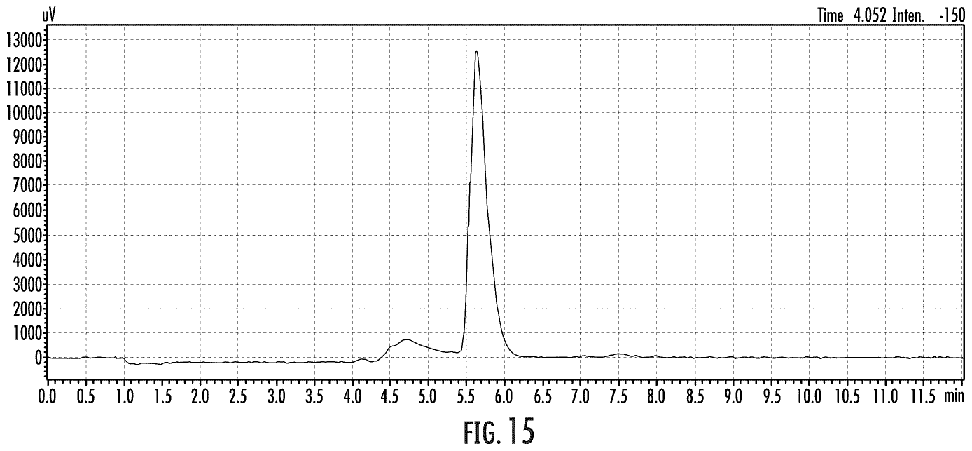

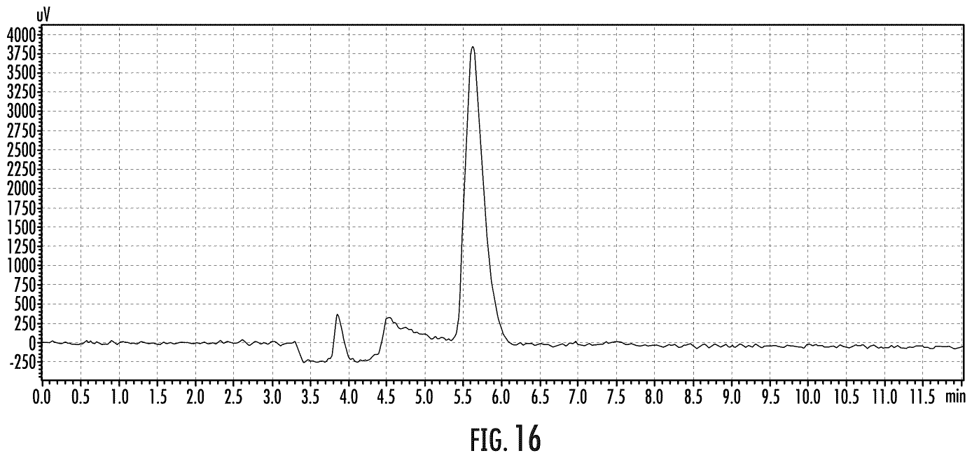

FIGS. 15 and 16 are chromatograms for a fucoxanthin reference standard (92.8% purity CAS: 3351-86-8; LOT: 00006296-941; ChromaDex, CA, USA), where in FIG. 15 the Limit of Quantification (LOQ) was 0.6 μg/mL, and in FIG. 16, the Limit of Detection (LOD) was 0.2 μg/mL. System noise may be observed.

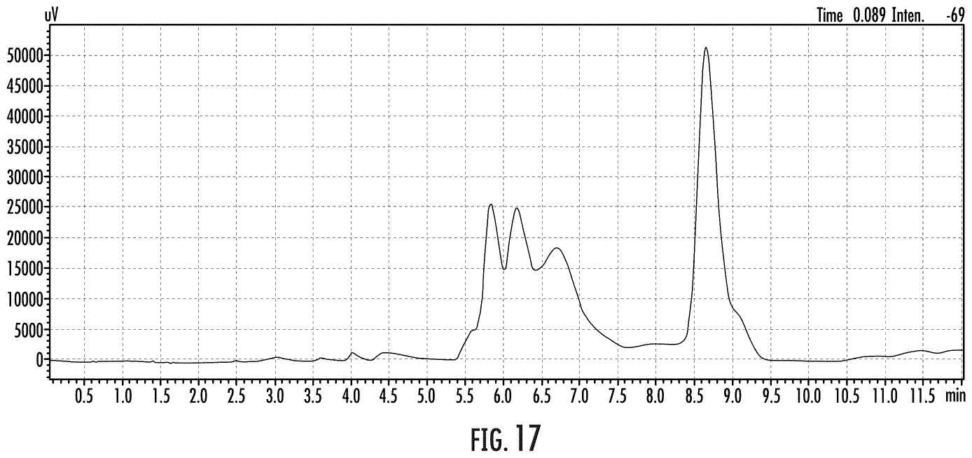

FIG. 17 is a chromatogram for fucoxanthin in a specific sample (LOT: NIGCHLA-2207V219719; NUTRACEUTICALS GROUP USA) where the retention time was 5.603 minutes.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A method for separating and quantifying fucoxanthin from complex matrices contained in raw materials or dietary supplements, comprising:
preparing a powdered fucoxanthin test sample from a raw material or dietary supplement having complex matrices containing fucoxanthin;
extracting fucoxanthin from the powdered fucoxanthin test sample by sequentially,
a) vortexing the powdered fucoxanthin test sample in a methanolic extract to form a test solution,
b) sonicating the test solution within an ultrasonic bath containing a buffer at a pH from about 7.15 to about 7.25, and
c) filtering the test solution through a 0.4 to 0.5 micron filter; and
performing a High-Performance Liquid Chromatography (HPLC) analysis on the filtered test solution using a C18 stationary phase column and isocratic methanol:acetonitrile mobile phase flowing through the column at a flow rate of about 0.7 to about 0.8 ml/min at about 26 to about 32 degrees Celsius with a concentration range of about 1.0 to about 20 micrograms per milliliter and a limit of detection (LOD) of about 0.2 micrograms/milliliter and a limit of quantitation (LOQ) of about 0.6 micrograms/milliliter.

2. The method of claim 1 wherein fucoxanthin is detected after HPLC at about 450 nanometers (nm) using an ultraviolet/visible light (UV/Vis) detector.

3. The method of claim 2 wherein fucoxanthin is detected at about 5.59 to about 5.89 minutes with a tailing factor of about 1.35 at about 5% height.

4. The method of claim 1 wherein a powdered fucoxanthin test sample that is equivalent to about 400 to 600 micrograms of fucoxanthin is vortexed for about 2 to 3 minutes in about 30 to about 35 milliliters of methanol.

5. The method of claim 4 wherein the test solution is sonicated for about 9 to about 11 minutes at about 38 to about 42 degrees Celsius, allowed to cool to room temperature, about 18 to 22 millimoles of potassium dihydrogen phosphate (H₂KPO₄) added to the test sample, mixed and sonicated again for about 9 to about 11 minutes at about 38 to about 42 degrees Celsius.

6. The method of claim 5 wherein after sonication, the test solution is cooled at room temperature and homogenized.

7. The method of claim 6 wherein the test solution is centrifuged at about 450 to about 550 rpm for about 4 to about 6 minutes.

8. The method of claim 1 wherein the C18 stationary phase column is about 4.6×150 millimeter and 5 micrometer and the injection volume of the test solution is about 20 microliters.

9. The method of claim 1 wherein the complex matrices comprise fucoxanthin-chlorophyll protein complexes (FCPs), pigments and proteins.

10. The method of claim 9 wherein the complex matrices comprise a biomass having a source of fucoxanthin and one or more of a diatom, brown algae, blue-green algae and green algae.

11. A method for separating and quantifying fucoxanthin from complex matrices contained in raw materials or dietary supplements, comprising:
preparing a powdered fucoxanthin test sample that is equivalent to about 400 to about 600 micrograms of fucoxanthin from a raw material or dietary supplement having complex matrices containing fucoxanthin comprising fucoxanthin-chlorophyll protein complexes (FCPs), pigments and proteins;
extracting fucoxanthin from the powdered fucoxanthin test sample by sequentially,
a) vortexing the powdered fucoxanthin test sample for about 2 to about 3 minutes in about 30 to about 35 milliliters of methanol to form a test solution,
b) sonicating the test solution within an ultrasonic bath for about 9 to about 11 minutes at about 38 to about 42 degrees Celsius, allowing to cool to room temperature, adding about 18 to 22 millimoles of potassium dihydrogen phosphate (H₂KPO₄) to the test sample as a buffer and imparting a pH of about 7.15 to about 7.25, mixing and sonicating again for about 9 to about 11 minutes at about 38 to about 42 degrees Celsius, and
c) filtering the test solution through a 0.4 to 0.5 micron filter; and
performing a High-Performance Liquid Chromatography (HPLC) analysis on the filtered test solution using a C18 stationary phase column and isocratic methanol:acetonitrile mobile phase flowing through the column at a flow rate of about 0.7 to about 0.8 ml/min at about 26 to about 32 degrees Celsius with a concentration range of about 1.0 to about 20 micrograms per milliliter and a limit of detection (LOD) of about 0.2 micrograms/milliliter and a limit of quantitation (LOQ) of about 0.6 micrograms/milliliter.

12. The method of claim 11 wherein fucoxanthin is detected after HPLC at about 450 nanometers (nm) using an ultraviolet/visible light (UV/Vis) detector.

13. The method of claim 12 wherein fucoxanthin is detected at about 5.59 to about 5.89 minutes with a tailing factor of about 1.35 at about 5% of height.

14. The method of claim 11 wherein after sonication, the test solution is cooled to room temperature and homogenized.

15. The method of claim 14 wherein the test solution is centrifuged at about 450 to about 550 rpm for about 4 to about 6 minutes.

16. The method of claim 11 wherein the C18 stationary phase column is about 4.6×150 millimeter and 5 micrometer and the injection volume of the test solution is about 20 microliters.

17. The method of claim 11 wherein the complex matrices further comprise a biomass having a source of fucoxanthin and one or more of a diatom, brown algae, blue-green algae and green algae.

18. A method for separating and quantifying fucoxanthin from complex matrices contained in raw materials or dietary supplements, comprising:
preparing a powdered fucoxanthin test sample from a raw material or dietary supplement having complex matrices containing fucoxanthin;
extracting fucoxanthin from the powdered fucoxanthin test sample by sequentially,
a) vortexing the powdered fucoxanthin test sample in a methanolic extract to form a test solution,
b) sonicating the test solution within an ultrasonic bath containing a buffer at a pH from about 7.15 to about 7.25, and
c) filtering the test solution through a 0.4 to 0.5 micron filter;
performing a High-Performance Liquid Chromatography (HPLC) analysis on the filtered test solution using a C18 stationary phase column that is about 4.6×150 millimeter and 5 micrometer and isocratic methanol:acetonitrile mobile phase with an injection volume of the test solution of about 20 microliters and flowing through the column at a flow rate of about 0.7 to about 0.8 ml/min at about 26 to about 32 degrees Celsius with a concentration range of about 1.0 to about 20 micrograms per milliliter, and a limit of detection (LOD) of about 0.2 micrograms/milliliter and a limit of quantitation (LOQ) of about 0.6 micrograms/milliliter; and
detecting fucoxanthin at about 450 nanometers (nm) using an ultraviolet/visible light (UV/Vis) detector.

19. The method of claim 18 wherein fucoxanthin is detected at about 5.59 to about 5.89 minutes with a tailing factor of about 1.35 at about 5% of height.

20. The method of claim 19 wherein a powdered fucoxanthin test sample equivalent to about 400 to 600 micrograms of fucoxanthin is vortexed for about 2 to 3 minutes in about 30 to about 35 milliliters of methanol.

21. The method of claim 20 wherein the test solution is sonicated for about 9 to about 11 minutes at about 38 to about 42 degrees Celsius, allowed to cool at room temperature, about 18 to 22 millimoles of potassium dihydrogen phosphate (H₂KPO₄) added to the test sample, mixed and sonicated again for about 9 to about 11 minutes at about 38 to about 42 degrees Celsius.

22. The method of claim 21 wherein after sonication, the test solution is cooled at room temperature and homogenized.

23. The method of claim 22 wherein the test solution is centrifuged at about 450 to about 550 rpm for about 4 to about 6 minutes.

24. The method of claim 18 wherein the complex matrices comprise fucoxanthin-chlorophyll protein complexes (FCPs), pigments and proteins.

25. The method of claim 24 wherein the complex matrices comprise a biomass having a source of fucoxanthin and one or more of a diatom, brown algae, blue-green algae and green algae.
